(19) United States
(12) Patent Application Publication
(10) Pub. No.: US 2024/0388043 A1
(43) Pub. Date: Nov. 21, 2024

(54) PLUG CONNECTOR WITH FUSE DEVICE, AND ASSEMBLY COMPRISING SUCH A PLUG CONNECTOR

(71) Applicant: PHOENIX CONTACT E-Mobility GmbH, Schieder-Schwalenberg (DE)

(72) Inventor: Cedric Deppe, Doerentrup (DE)

(21) Appl. No.: 18/693,168

(22) PCT Filed: Sep. 22, 2022
(86) PCT No.: PCT/EP2022/076355

§ 371 Date: Mar. 19, 2024

(30) Foreign Application Priority Data
Sep. 24, 2021 (LU) LU500684

(51) Int. Cl. H01R 13/684

(52) U.S. Cl. CPC H01R 13/684

(57) ABSTRACT

A plug connector for establishing a plug connection together with a mating plug connector includes: at least one first connecting portion for connecting to a first connecting device to transmit electrical energy and/or electrical signals; a fuse circuit for deactivating a transmission of electrical energy; and at least one fuse device actuable and operatively connected at least to the at least one first connecting portion and to the fuse circuit, the at least one fuse device, in a first state, blocking the at least one first connecting portion for establishing a connection with the first connecting device and at least interrupting the fuse circuit to deactivate the transmission of electrical energy.

### CROSS-REFERENCE TO PRIOR APPLICATIONS

This application is a U.S. National Phase application under 35 U.S.C. § 371 of International Application No. PCT/EP2022/076355, filed on Sep. 22, 2022, and claims benefit to Luxembourg Patent Application No. LU 500684, filed on Sep. 24, 2021. The International Application was published in German on Mar. 30, 2023 as WO/2023/046826 under PCT Article 21(2).

### FIELD

The present invention lies in the field of electrical engineering and relates to a plug connector for establishing a plug connection with a mating plug connector in order to transmit electrical energy and/or electrical signals. The plug connector has a fuse device. The present invention further relates to an assembly comprising such a plug connector and comprising a first and a second plug-in device.

### BACKGROUND

In the case of electric vehicles or hybrid vehicles, for example, auxiliary units are supplied with power through a high-voltage power distributor in order to minimize power losses as far as possible. Above all, the power must be transmitted safely and with low loss, wherein the cables and plug connections primarily represent a particular challenge in the development of an on-board power supply network. For example, shielded cables with increased dielectric strength are used to transmit high currents. On the other hand, during a maintenance process, corresponding precautions must also be taken, for example by means of a corresponding housing design, to ensure that high-voltage (HV) current-carrying components cannot be touched.

Furthermore, fuse devices are used to shut down the entire HV on-board power supply network. Thus, for example, a safety, i.e., shutdown, function for the HV components is known in the case of a Hazardous Voltage Interlock Loop or High-Voltage Interlock Loop (HVIL for short), the interruption of which components ensures that the HV on-board power supply network is shut down. In the case of charging cables and drive cables of an electric vehicle, an HVIL circuit is usually used, which monitors the correct connection of each HV plug connection by means of lagging contacts.

Because HV plug connectors also expose voltage-carrying components, these connection points must also be connected to the HVIL circuit, as a result of which signal distribution is required in addition to power distribution.

A plug connection for connecting an HVIL circuit requires a bridge on one side and two individual contacts on the opposite side, which are integrated into the HVIL circuit in a series connection by electrical cables. If the HVIL circuit is interrupted, the HV component is immediately deenergized. Contact with voltage-carrying components is thus avoided.

In order to realize a combined AC and DC charging socket according to the Combined Charging System (CCS) plug system standard, which allows DC and AC charging with Type 1-CCS, Type 2-CCS and Combo-2 plug connections, or according to the new charging system originating from Asia called “ChaoJi stacked” with individual disconnection points (connecting portions) to the electrical cables, two contact pairs for two HVIL circuits would be required, which are ideally already connected in series within the charging socket.

Implementing two individual contact pairs for HVIL functionality at different positions of a charging socket and connecting them in series is, for example, complex, requires space and is therefore expensive.

For example, published patent application DE 10 2016 101 299 A1 discloses an electric vehicle that does not use an HVIL circuit and instead uses a control unit and corresponding sensors.

### SUMMARY

In an embodiment, the present invention provides a plug connector for establishing a plug connection together with a mating plug connector, comprising: at least one first connecting portion configured to connect to a first connecting device to transmit electrical energy and/or electrical signals: a fuse circuit configured to deactivate a transmission of electrical energy; and at least one fuse device configured so as to be actuable and operatively connected at least to the at least one first connecting portion and to the fuse circuit, the at least one fuse device configured so as, in a first state, to block the at least one first connecting portion for establishing a connection with the first connecting device and to at least interrupt the fuse circuit to deactivate the transmission of electrical energy.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of an assembly with an embodiment of the plug connector according to the present invention, a first connecting device to be connected to the plug connector, and a second connecting device to be connected to the plug connector, wherein the fuse device is shown in a first state;

FIG. 2 shows the assembly from FIG. 1 in a side view:

FIG. 3 shows the assembly from FIG. 1, wherein the second connecting device is connected to the plug connector:

FIG. 4 shows the assembly from FIG. 3, wherein the fuse device is shown in a second state:

FIG. 5 shows the assembly from FIG. 4 in a side view:

FIG. 6 is a perspective view of the assembly from FIG. 5, wherein the first connecting device is connected to the plug connector:

FIG. 7A shows the assembly from FIG. 6 in a front view;

FIG. 7B shows the assembly from FIG. 6 in a side view; and

FIG. 8 shows the assembly from FIG. 6 in a plan view.

### DETAILED DESCRIPTION

In an embodiment, the present invention provides an improved plug connector comprising at least one fuse device for establishing a plug connection with a mating plug connector in order to transmit electrical energy and/or electrical signals, wherein the plug connector is characterized primarily by a simple, space-saving structure and cost-effective production, as well as by a defined or predetermined assembly and disassembly sequence. An embodiment of the present invention provides an assembly comprising a plug connector.

According to a first general aspect, the invention relates to a plug connector, preferably a charging socket, for establishing a plug connection with a mating plug connector, preferably a charging plug, wherein the plug connector has at least one first connecting portion for connecting to a first connecting device in order to transmit electrical energy and/or electrical signals, wherein the plug connector has a fuse circuit, preferably a single fuse circuit comprising a single contact pair for deactivating the transmission of electrical energy, and at least one fuse device, wherein the at least one fuse device is configured so as to be actuable, preferably manually actuable, and is operatively connected at least to the at least one first connecting portion and to the fuse circuit, and is configured so as to block, preferably mechanically, the at least one first connecting portion for establishing a connection with the first connecting device and to at least interrupt the fuse circuit, preferably at the same time as when it blocks the at least one first connecting portion, in a first state or in a first position in order to deactivate the transmission of electrical energy.

The first connecting device can, for example, be a plug that is installed on the plug connector for further transmission of electrical energy and/or electrical signals, which are provided by a mating plug connector in the state in which a plug connection is established.

By means of the present invention, for example, a plug connector can be provided that dispenses with two or more contact pairs of an HVIL circuit or thus with two or more HVIL circuits, but nevertheless provides the necessary and/or sufficient safety with respect to the deactivation of current-carrying components.

Furthermore, the plug connector according to the present invention can ensure a defined or predetermined sequence with regard to the assembly or disassembly and maintenance of the plug connector. A plug connector is thus provided that is characterized, for example, by an enhanced safety aspect.

According to a further aspect of the invention, it can be provided that the plug connector has at least one second connecting portion for connecting to a second connecting device in order to transmit electrical energy and/or electrical signals, wherein the at least one fuse device is configured so as to block the at least one second connecting portion for establishing or breaking a connection with the second connecting device in a second state or a second position, which is preferably different from the first state or first position, and to release the at least one first connecting portion in order to close or activate the fuse circuit via the first connecting device, i.e., by establishing a connection between the first connecting device and the at least one first connecting portion, in order to allow the transmission of electrical energy.

In other words, the at least one fuse device can be configured so as to release, upon corresponding actuation from the first state or from the first position to a second state or into a second position, the at least one first connecting portion for connection to the first connecting device and to block, preferably simultaneously, the at least one second connecting portion. Thus, a plug connector can be provided that is characterized by a first connecting device and a second connecting device in order to be able to transmit electrical energy, for example in the form of direct current and, additionally alternatively, in the form of alternating current, which is primarily characterized by a safety concept.

It is possible for the at least one fuse device to be configured so as to be actuable in the first state or in the first position before establishing the connection with the first connecting device, or to be at least actuable in order to release the at least one first connecting portion.

The fuse circuit can preferably be interrupted or closed from the first connecting device or by the first connecting device, depending on whether or not a connection is established with the at least one first connecting portion.

It is possible for the at least one fuse device to be configured so as to be blocked in the second state or in the second position when the connection with the first connecting device is established. The at least one fuse device can preferably not be actuated in this state or in this position and is then (self-) blocked. Actuation of the at least one fuse device is only possible if the connection between the at least one first connecting portion and the first connecting device has been released or broken, preferably mechanically and electrically.

According to a further aspect of the invention, it can be provided that the at least one fuse device is designed as a lever element or comprises a lever element, and/or that the at least one fuse device comprises a mounting portion at a free end, which is preferably configured for mounting on the at least one first connecting portion in a manner pivotable or rotatable about an axis between the first state or the first position and a second state or a second position. The at least one fuse device can be configured so as to be pivotably actuable.

It is also possible for the at least one fuse device to be designed to be translationally actuable. For example, the at least one fuse device can be designed as a carriage element or comprise a carriage element. The carriage element can be substantially flat and/or substantially plate-like, at least in portions. The at least one fuse device can, for example, be mounted so as to move in a translational manner on at least one rail or in at least one groove in the housing of the plug connector, i.e., on a wall or on a wall portion, preferably substantially perpendicularly to the at least one first connecting portion and/or between the at least one first connecting portion and the at least one second connecting portion. The at least one first connecting portion can be configured to establish a plug connection with the first connecting device and thus have a plug face comprising a plug portion. The at least one first fuse device can be mounted so as to be translationally actuable substantially perpendicularly to the plug face and/or the plug portion of the at least one first connecting portion.

Furthermore, it is additionally or alternatively possible for the at least one fuse device to be designed to be translationally and/or rotationally actuable. The at least one fuse device can be designed and/or configured so as to be at least partially rotating (rotatable) and at least partially displaceable for actuation purposes. The at least one fuse device can comprise at least one mounting portion that is configured for translational and/or rotational mounting between the first state or first position and a second state or second position.

According to a further aspect of the invention, it can be provided that the at least one fuse device has at least one locking element at its free end opposite or adjacent to the mounting portion, wherein the at least one locking element is configured so as to establish a releasable positive connection, preferably to the at least one second connecting portion.

As a result, for example, the fuse device can be sufficiently attached to the plug connector and cannot come loose under mechanical stress, for example vibration. The locking element may be designed as a latching element, for example.

It is possible for the at least one fuse device to have at least one cover portion or a cover element that is configured so as to at least partially cover the at least one second connecting portion, wherein preferably the at least one cover portion or the at least one cover element is arranged between a mounting portion and a free end opposite or adjacent to the mounting portion.

It is possible for the at least one fuse device to be designed to be substantially flat, at least in portions, and/or substantially plate-like, at least in portions, and/or angled, at least in portions. This can ensure, for example, easy handling of at least one fuse device.

According to a further aspect of the invention, it can be provided that the at least one fuse device is biased by at least one spring element, wherein the at least one spring element preferably biases the at least one fuse device in order to reach the first state or first position. The at least one spring element can be, for example, a helical spring, which is preferably arranged on the mounting portion of the fuse device and is supported on the housing, i.e., on a wall or wall portion of the plug connector.

According to a further aspect of the invention, it can be provided that the fuse circuit is configured so as to deactivate the transmission of electrical energy via the connection of the at least one first connecting portion to the first connecting device, or via a connection of at least one second connecting portion with a second connecting device, and/or comprises a High-Voltage Interlock Loop circuit or is designed as a High-Voltage Interlock Loop circuit.

It is possible that the connection between the at least one first connecting portion and the first connecting device is designed as a plug connection, or comprises a plug connection, and/or the connection between at least one second connecting portion and a second connecting device is designed as a screw connection, or comprises a screw connection.

According to a further aspect of the invention, it can be provided that the at least one fuse device has at least one projection, wherein the at least one projection is designed to block the at least one first connecting portion, preferably in the first state or first position of the fuse device.

It is possible for the at least one projection to project, at least in portions, into the at least one first connecting portion in order to block the at least one first connecting portion, and/or to be formed in one piece with the at least one fuse device.

According to a further aspect of the invention, it can be provided that the plug connector has a plug face having at least one first plug portion and at least one second plug portion on one end face, wherein the at least one first plug portion is electrically connected to the at least one first connecting portion and/or is arranged opposite thereto, and/or that the at least one second plug portion is electrically connected to the at least one second connecting portion and/or is arranged opposite thereto.

According to a second general aspect, the invention relates to a plug connector as disclosed herein, to a first connecting device and to a second connecting device.

Identical or functionally equivalent elements are denoted by the same reference signs in the drawings. For the explanation thereof, reference is also made in part to the description of other exemplary embodiments and/or Figures in order to avoid repetitions.

The following detailed description of the exemplary embodiments illustrated in the figures serves for more detailed illustration or clarification and is not intended to limit the scope of the present invention in any way.

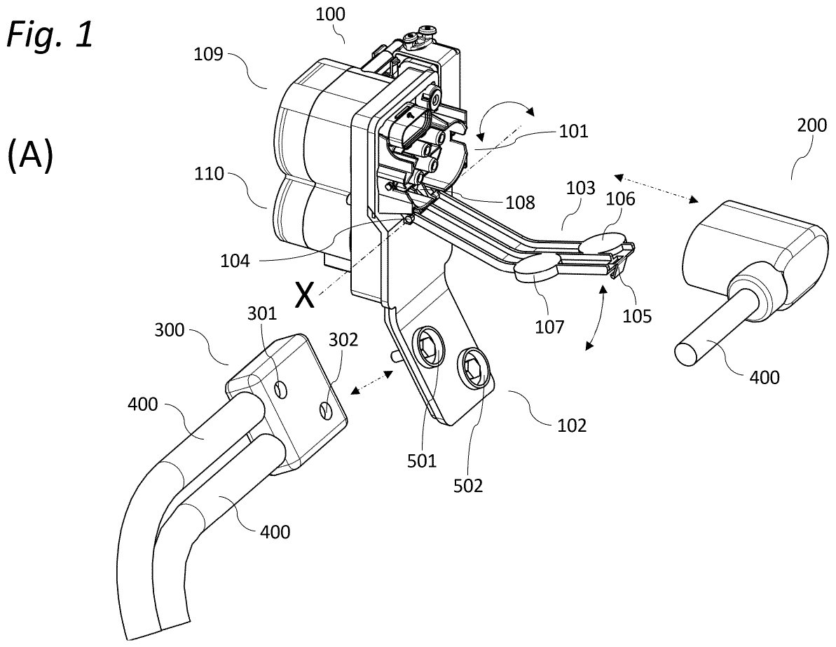

FIG. 1 is a perspective view of an assembly with an embodiment of the plug connector 100 according to the present invention, a first connecting device 200 to be connected to the plug connector 100, and a second connecting device 300 to be connected to the plug connector 100. Both the first connecting device 200 and the second connecting device 300 are provided for mechanical connection and electrical connection to the plug connector 100 in order to transmit electrical energy and/or electrical signals, which will be described in more detail below.

The plug connector 100 is preferably designed as a charging socket 100 for an electrically drivable vehicle (for example an electric vehicle or a hybrid vehicle) and has a housing having walls and/or wall portions that are not specified in detail herein. The housing of the plug connector 100 can be made substantially of an insulating material, and/or can be produced by at least one injection-molding process and/or by at least one casting process.

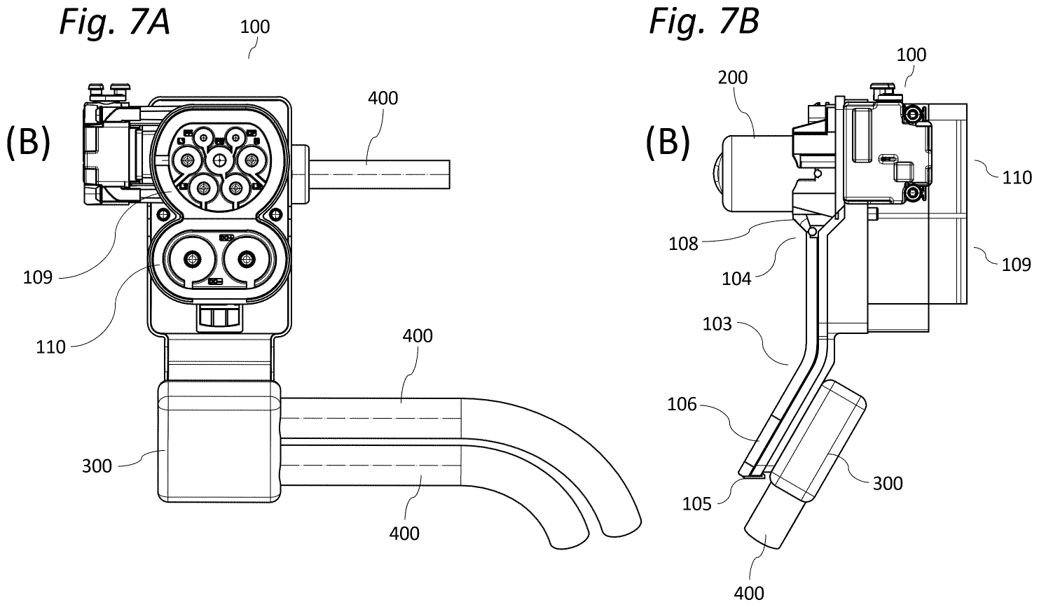

The plug connector 100 is configured so as to establish a plug connection with a mating plug connector, preferably in the form of a charging plug. For this purpose, the plug connector 100 has a plug face having a first plug portion 109 and having a second plug portion 110 on one end face. The plug connector 100 can preferably be designed according to the so-called Combined Charging System (CCS) for fast charging, which is standardized in Part 3 of IEC 62196 (DIN EN 62196). The plug connector 100 can be designed and/or configured according to the Type 1-CCS standard or according to the Type 2-CCS standard. The plug connector 100 is thus able to provide both DC charging processes and AC charging processes in an electrically drivable vehicle. Preferably, the plug connector 100 is based on the Type 2 vehicle coupling and has, within the second plug portion 110, two electrical contact elements for transmitting electrical energy in the form of direct current (see also FIG. 7A in this regard). Furthermore, the plug connector 100 comprises a first plug portion 109 in which corresponding electrical contact elements are arranged. These are electrical contact elements for transmitting electrical energy in the form of alternating current (single-phase to three-phase) and/or electrical signals.

In addition to the electrical contact elements for transmitting electrical energy, a protective earth conductor contact element (PE contact element with earth potential) and signal contact elements (“Control Pilot” for the dialog between the charging station and the vehicle and “Proximity Pilot” for limiting the charging current by means of resistor coding) are thus arranged in the first plug portion 109 (see also FIG. 7A in this regard).

Alternatively, it is possible for the plug connector 100 to be designed according to another standard or another specification, for example according to the “CHAdeMO Standard” or according to the “ChaoJi stacked specification.”

The plug connector 100 is configured so as to be operable within a high-voltage/high-current on-board power supply network architecture. The power of such an on-board power supply network architecture for charging electrically drivable vehicles reaches, for example, up to 350 KW at a current of 400 A or even up to 500 KW at a current of 600 A.

The plug connector 100 has a first connecting portion 101 and a second connecting portion 102 in order to transmit electrical energy and/or electrical signals. Both the first connecting portion 101 and the second connecting portion 102 are arranged and/or formed on the side opposite the plug face having the plug portions 109 and 110. The first connecting portion 101 is electrically connected to the first plug portion 109, and the second connecting portion 102 is electrically connected to the second plug portion 110.

The first connecting portion 101 comprises a plug face corresponding to the first plug portion 109 and having a plug portion in which corresponding contact elements are arranged. The first connecting portion 101 is configured so as to establish a positive connection to the first connecting device 200. The first connecting device 200 is designed as a plug and is connected to at least one electrical cable 400 in order to transmit the electrical energy and/or electrical signals. In other words, the first connecting portion 101 and the first connecting device 200 are configured so as to establish a releasable plug connection in order to transmit electrical energy and/or electrical signals. However, the first connecting device 200 can only be plugged into the first connecting portion 101 in certain states of the plug connector 100 and in particular in this case of the first connecting portion 101 in order to establish electrically conductive connections, which will be described in more detail below.

The plug connector 100 comprises a fuse circuit for deactivating the transmission of electrical energy or is connected to a fuse circuit for deactivating the transmission of electrical energy. In the present embodiment of the plug connector 100, the fuse circuit is configured to deactivate the transmission of electrical energy via the connection of the first connecting portion 101 to the first connecting device 200. In other words, the fuse circuit can be closed by forming a connection between the first connecting device 200 and the first connecting portion 101 or can be interrupted by breaking the connection between the first connecting device 200 and the first connecting portion 101.

The fuse circuit is connected via a contact pair to corresponding electrical cables and/or to electrically conductive components of the plug connector 100, and in particular in this case of the first connecting portion 101. The fuse circuit is used to monitor the electrical connection between the first connecting portion 101 and the first connecting device 200. The fuse circuit preferably comprises a High-Voltage Interlock Loop circuit (“HVIL circuit”) or is designed as a High-Voltage Interlock Loop circuit (“HVIL circuit”).

Alternatively, i.e., in a further, alternative embodiment of the plug connector 100, it is possible for the fuse circuit to be used to monitor the electrical connection between the second connecting portion 102 and the second connecting device 300. According to the present invention, if there are two connecting portions 101, 102 for transmitting electrical energy and/or electrical signals, preferably precisely one fuse circuit is necessary, which shall be clear from the following description of further components of the plug connector 100.

The fuse circuit is thus configured so as to deactivate the transmission of electrical energy in the event of an interruption (currentless and/or interrupted state of the fuse circuit) and thus immediately deenergize the high-voltage system of the plug connector 100. Contact with voltage-carrying components, for example during maintenance of the plug connector 100 or disassembly of the plug connector 100 or of components of the plug connector 100, can thereby be avoided.

The second connecting portion 102 is substantially flat and substantially plate-like, at least in portions, and arranged opposite the second plug portion 110 and next to the first connecting portion 101. The second connecting portion 102 of the plug connector 100 is designed to be angled, at least in portions, wherein the angled portion projects in the plug-in direction in order to establish a plug connection between the plug connector 101 and a mating plug connector. The second connecting portion 102 is configured so as to be releasably connected to the second connecting device 300 in the form of a plug via an electrically conductive first screw connection 501 and an electrically conductive second screw connection 502. The second connecting device 300 is connected to at least two electrical cables 400 and is used to transmit electrical energy in the form of direct current.

According to the invention, the plug connector 100 has a fuse device 103. The fuse device 103 is configured so as to be actuable, preferably so as to be manually actuable. The fuse device 103 is operatively connected at least to the first connecting portion 101 and to the fuse circuit. In other words, actuation of the fuse device 103 correspondingly acts on the first connecting portion 101 and (downstream or furthermore) on the fuse circuit. It is preferably possible for the fuse device 103 to further likewise be operatively connected to the second connecting portion 102.

The fuse device 103 is configured, during or in a first state A or first position A, to block or lock, preferably mechanically, the at least one first connecting portion 101 in order to establish a connection to the first connecting device 200, and to at least interrupt the fuse circuit or leave the fuse circuit in an interrupted state in order to deactivate the transmission of electrical energy, i.e., to deenergized current-carrying components of the plug connector 100 immediately or promptly or keep them deenergized. Due to the blocking of the first connecting portion 101, it is not possible to establish a plug connection between the first connecting portion 101 and the first connecting device 200.

The first connecting portion 101 is blocked in the first state A or in the first position A by the fuse device 103. The fuse device 103 is configured so as to be actuated or at least actuable in order to release the first connecting portion 101 before establishing the connection between the first connecting portion 101 and the first connecting device 200. In order to realize the blocking function or locking function of the first connecting portion 101, the design of the fuse device 103 and its arrangement with respect to the plug connector 100 will be described in more detail below.

The fuse device 103 is preferably designed as a lever element or preferably comprises a lever element. The fuse device 103 is designed to be angled, preferably analogously to the design of the second connecting portion 102, and is at substantially flat and/or substantially plate-like, at least in portions. The fuse device 103 comprises a mounting portion 104 at a free end. The mounting portion 104 is designed for mounting the fuse device 103 on the housing of the plug connector 100, i.e., on a wall or on a wall portion, so as to be pivotable about an axis X from the first state A or from the first position A to a second state B or to a second position B. The mounting portion 104 is pivotably mounted on the housing of the plug connector 100, for example by means of a bolt connection. The bolt connection and thus the pivotable mounting of the fuse device 103 can preferably be arranged on the first connecting portion 101, i.e., adjacent to the first connecting portion 101.

The fuse device 103 comprises a projection 108 that is preferably arranged and/or formed on or in the region of the mounting portion 104. The projection 108 is designed to block the first connecting portion 101, preferably in the first state A or in the first position A of the fuse device 103. The projection 108 projects over a corresponding recess in the first connecting portion 101, which recess is designed, for example, as a slot, and, at least in portions, into the plug region of the first connecting portion 101 and thus prevents the possibility of establishing a plug connection to the first connecting device 200.

The fuse device 103 further comprises a first cover element 106 and a second cover element 107. Both the first cover element 106 and the second cover element 107 are used to cover the screw connections 501 and 502 on the second connecting portion 102.

The projection 108 and the cover elements 106 and 107 are preferably formed in one piece with the fuse device 103 in the form of the lever element. In other words, the fuse device 103 is designed as a cover that is pivotably mounted on the plug connector 100. Furthermore, the fuse device 103 is designed to mechanically block the first connecting device 200 in the first state A or in the first position A. As already explained above, in this first state A or in this first position A, the fuse circuit is interrupted by the fuse device 103. All current-carrying parts are deenergized so that there is no risk in the event of electrically conductive components being present.

In the first state A or in the first position A, the fuse device 103 is located in a state pivoted away from the second connecting portion 102. Thus, the screw connections 501 and 502 are not covered by the cover elements 106 and 107. It is thereby possible, for example, to install the second connecting device 300 on the second connecting portion 102 via the screw connections 501 and 502 or to remove an already installed second connecting device 300. FIG. 1 shows a state in which the second connecting device 300 is yet to be mounted on the second connecting portion 102 in order to establish an electrically conductive connection.

As described above, in an alternative embodiment, the fuse device 103 can be designed to be translationally movable and/or mounted. The fuse device 103 can be mounted as a substantially flat and/or substantially plate-like carriage element 103 on at least one rail or groove, preferably between two rails or grooves arranged opposite one another and spaced apart from one another, of the housing of the plug connector 100, preferably so as to be movable from the first state A or the first position A to the second state B or the second position B and vice versa. In one view, preferably in a plan view, the fuse device 103 can have a substantially rectangular contour. Furthermore, the fuse device 103 can have at least one projection 108, as disclosed herein, for blocking the first connecting portion 101 on an end side, i.e., an end surface of the end side.

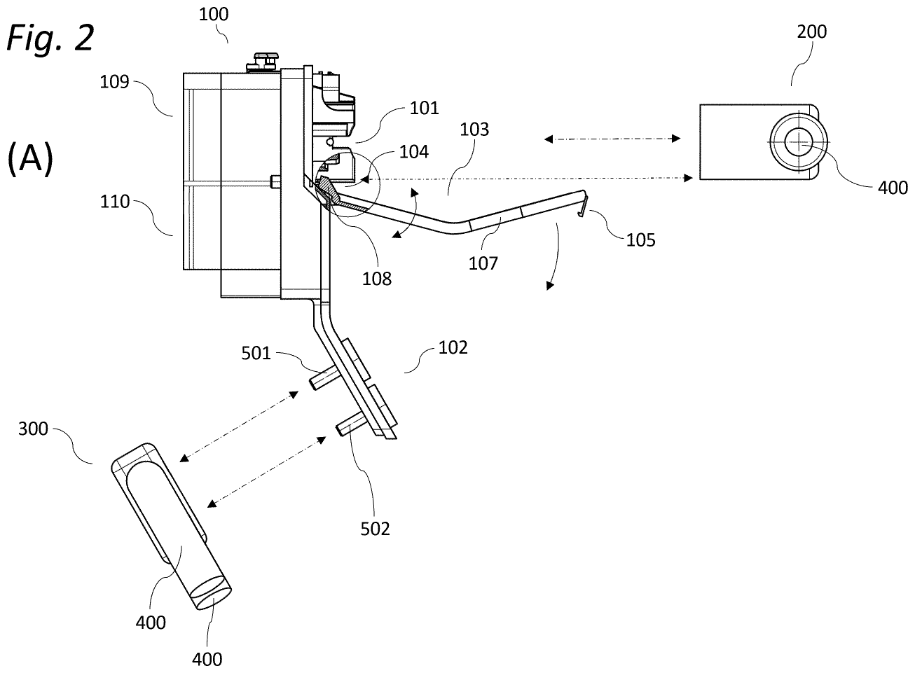

FIG. 2 shows the assembly from FIG. 1 in a side view.

The design of the projection 108 and its arrangement on the fuse device 103 in the region of the mounting portion 104 can be clearly seen. The projection 108 projects, at least in portions, into the plug region of the first connecting portion 101 in order to block it with respect to the establishment of a plug connection with the first plug device 200.

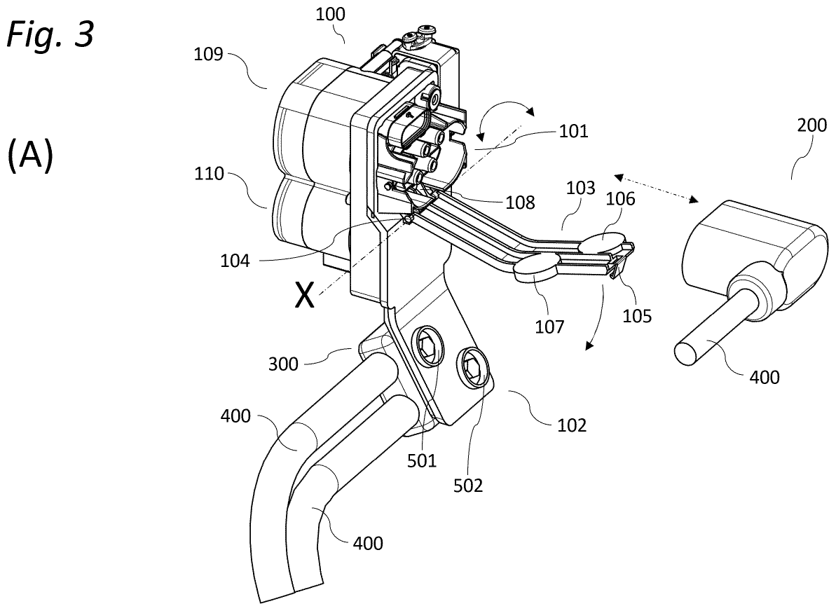

FIG. 3 shows the assembly from FIG. 1, wherein the second connecting device 300 is mechanically and simultaneously electrically conductively connected to the plug connector 100. The second connecting device 300 is releasably attached to the second connecting portion 102 via the screw connections 501 and 502. In other words, in the first state A or in the first position A of the fuse device 103, it is possible to releasably connect the second connecting device 300 to the second connecting portion 102 once the cover elements 106 and 107 are in a state pivoted away from the screw connections 501 and 502.

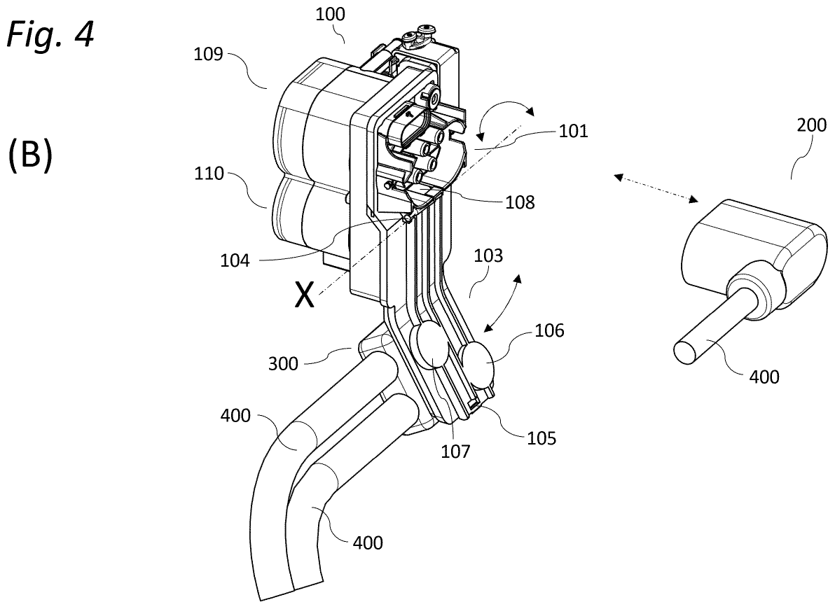

FIG. 4 shows the assembly from FIG. 3, wherein the fuse device 103 is now shown in a second state B or in a second position B.

In this second state B or in this second position B of the fuse device 103, the projection 108 of the fuse device 103 is pivoted outside the first connecting portion 101 so that a plug connection can be established between the first connecting portion 101 and the first plug device 200 in order, inter alia, to close and/or activate the fuse circuit. In other words, the first connecting portion 101 is released to establish a plug connection with the first plug device 200.

Furthermore, at the same time in the second state B or in the second position B, the second connecting portion 102 of the plug connector 100 is covered by the fuse device 103. In this case, the cover elements 106 and 107 cover the corresponding screw connection 501 and 502 so that the assembly or disassembly of the second connecting device 300 is not possible in this state or in this position of the fuse device 103. Thus, a corresponding assembly sequence or disassembly sequence of the corresponding connecting devices 200 and 300 is thereby predetermined by the state or the position of the fuse device 103.

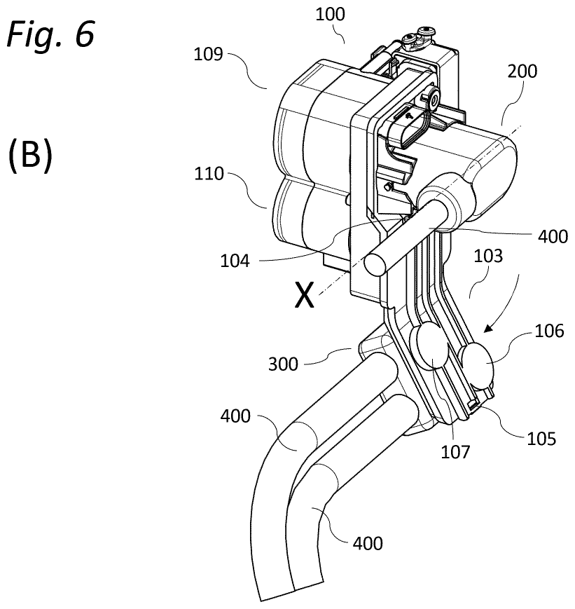

In the state shown in FIG. 4, the fuse circuit can be closed or activated by the first connecting device 200 by the movement of the fuse device 103. The transmission of electrical energy is then possible via the first plug portion 109 and the first connecting device 200 or via the second plug portion 110 and the second connecting device 300 (see also the other drawings, FIGS. 6 to 8 in this regard).

As can be seen from viewing FIGS. 1 to 4 together, the fuse device 103 has a locking element 105 at its free end opposite the mounting portion 104. The locking element 105 is configured so as to establish a releasable positive connection, preferably a latching connection, to the second connecting portion 102. Thus, for example, unintentional or unwanted release of the fuse device 103 can be prevented, for example in the event of mechanical stress on the plug connector 100, for example in the form of vibrations.

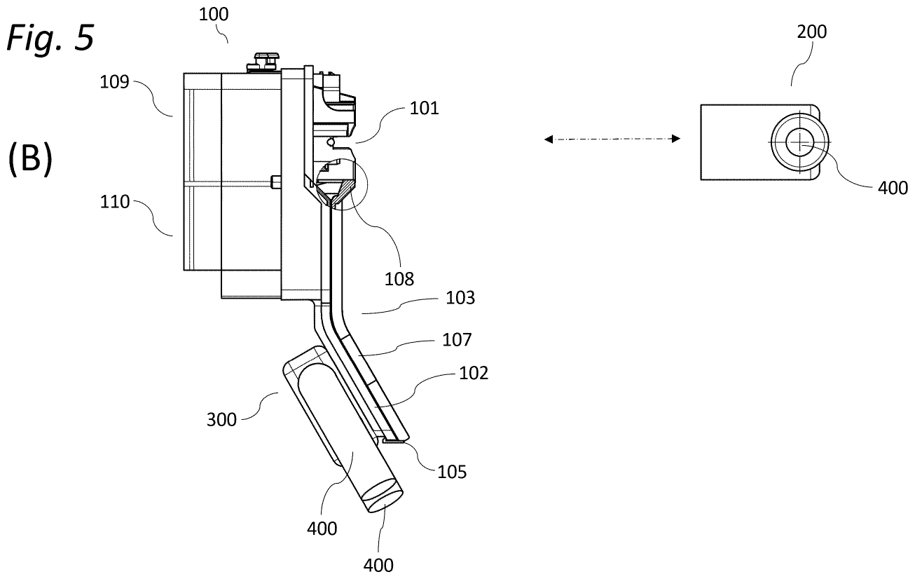

FIG. 5 shows the assembly from FIG. 4 in a side view.

FIG. 6 shows the assembly from FIG. 5 in a perspective view, wherein the first connecting device 200 is now also connected to the plug connector 100, i.e., to the first connecting portion 101 of the plug connector 100. In the second state B or in the second position B of the fuse device 103, the first connecting device 200 can now be plugged into the first connecting portion 101.

FIG. 7A shows the assembly from FIG. 6 in a front view. The plug face of the plug connector 100 having the first plug portion 109 and the second plug portion 110, as well as each of the contact elements (not indicated in more detail in FIG. 7A) arranged therein for transmitting electrical energy and/or electrical signals are clearly visible.

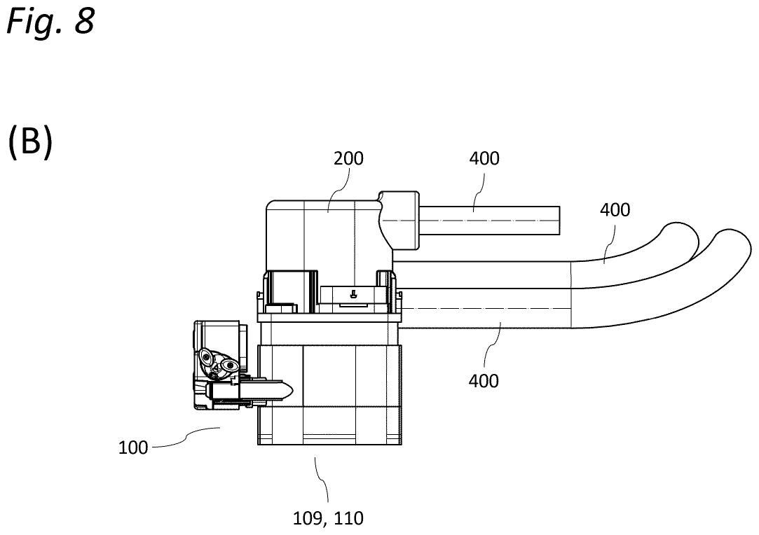

FIG. 7B shows the assembly from FIG. 6 in a side view, and FIG. 8 shows the assembly from FIG. 6 in a plan view.

According to a further embodiment of the present invention, the fuse device 103 can be biased by at least one spring element, for example a helical spring element, wherein the spring element preferably acts on the fuse device 103 with a bias and preferably biases the fuse device 103 in order to reach the first state A or the first position A.

A combined safety system can be provided with the plug connector 100 according to the present invention, which safety system has a mechanical fuse device and preferably requires only a single electrical fuse device in the form of a fuse circuit, preferably an HVIL circuit.

The plug connector 100 according to the present invention is also characterized by a simple and cost-effective structure, which is also space-saving. Above all, the fuse device 103 is easy to operate and ensures a defined, safe procedure for maintaining and/or installing the plug connector 100 and the connecting devices 200 and 300.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Plug connector
101 First connecting portion
102 Second connecting portion
103 Fuse device
104 Mounting portion
105 Locking element
106 First cover portion
107 Second cover portion
108 Projection
109 First plug portion
110 Second plug portion
200 First connecting device
300 Second connecting device
400 (Electrical) cable
501 First screw connection
502 Second screw connection
A First state/first position
B Second state/second position
X Axis

1. A plug connector for establishing a plug connection together with a mating plug connector, comprising:
at least one first connecting portion configured to connect to a first connecting device to transmit electrical energy and/or electrical signals;
a fuse circuit configured to deactivate a transmission of electrical energy; and
at least one fuse device configured so as to be actuable and operatively connected at least to the at least one first connecting portion and to the fuse circuit, the at least one fuse device
configured so as, in a first state, to block the at least one first connecting portion for establishing a connection with the first connecting device and to at least interrupt the fuse circuit to deactivate the transmission of electrical energy.

2. The plug connector of claim 1,
further comprising:
at least one second connecting portion configured to connect to a second connecting device to transmit electrical energy and/or electrical signals,
wherein the at least one fuse device is configured to block the at least one second connecting portion for establishing or breaking a connection with the second connecting device in a second state in order to close the fuse circuit via the first connecting device to allow the transmission of electrical energy.

3. The plug connector of claim 1,
wherein the at least one fuse device is configured so as to be actuated in the first state before establishing the connection with the first connecting device in order to release the at least one first connecting portion.

4. The plug connector of claim 1,
wherein the at least one fuse device is configured so as to be blocked in the second state when the connection to the at least one first connecting device is established.

5. The plug connector of claim 1,
wherein the at least one fuse device comprises a lever element or comprises a lever element, and/or
wherein the at least one fuse device comprises a mounting portion at a free end.

6. The plug connector of claim 1,
wherein the at least one fuse device comprises a carriage element, and/or
wherein the at least one fuse device comprises at least one mounting portion configured for translational mounting and/or rotational mounting between the first state and a second state.

7. The plug connector of claim 5,
wherein the at least one fuse device has at least one locking element at a free end thereof opposite or adjacent to the mounting portion, and
wherein the at least one locking element is configured to establish a releasable positive connection.

8. The plug connector of claim 2,
wherein the at least one fuse device has at least one cover portion or a cover element configured so as to at least partially cover the at least one second connecting portion.

9. The plug connector of claim 1,
wherein the at least one fuse device is flat, at least in portions, and/or plate-like, at least in portions, and/or angled, at least in portions.

10. The plug connector of claim 1,
wherein the at least one fuse device is biased by at least one spring element.

11. The plug connector of claim 1,
wherein the fuse circuit is configured to deactivate the transmission of electrical energy via the connection of the at least one first connecting portion to the first connecting device, or via a connection of at least one second connecting portion to a second connecting device, and/or
wherein the fuse circuit comprises a High-Voltage Interlock Loop circuit or comprises a High-Voltage Interlock Loop circuit.

12. The plug connector of claim 1,
wherein the connection between the at least one first connecting portion and the first connecting device comprises a plug connection, and/or
wherein the connection between at least one second connecting portion and a second connecting device comprises a screw connection.

13. The plug connector of claim 1,
wherein the at least one fuse device has at least one projection, and
wherein the at least one projection is configured to block the at least one first connecting portion.

14. The plug connector of claim 13,
wherein the at least one projection projects, at least in portions, into the at least one first connecting portion in order to block the at least one first connecting portion, and/or is formed in one piece with the at least one fuse device.

15. The plug connector of claim 1,
further comprising:
a plug face having at least one first plug portion and at least one second plug portion on one end face,
wherein the at least one first plug portion is electrically connected to the at least one first connecting portion and/or is arranged opposite thereto, and/or
wherein the at least one second plug portion is electrically connected to the at least one second connecting portion and/or is arranged opposite thereto.

16. An assembly, comprising:
the plug connector of claim 1;
a first connecting device; and
a second connecting device.

17. The plug connector of claim 5, wherein the mounting portion is configured for mounting on the at least one first connecting portion so as to be pivotable about an axis between the first state and a second state.

18. The plug connector of claim 7, wherein the at least one locking element is configured to establish a releasable positive connection to the at least one second connecting portion.

19. The plug connector of claim 8, wherein the at least one cover portion or the cover element is arranged between a mounting portion and a free end opposite or adjacent to the mounting portion.

20. The plug connector of claim 10, wherein the at least one spring element is configured to bias the at least one fuse device in order to reach the first state.
